(19) United States
(12) Patent Application Publication
(10) Pub. No.: US 2022/0201778 A1
(43) Pub. Date: Jun. 23, 2022

(54) METHOD AND APPARATUS FOR DATA TRANSMISSION, AND VEHICLE

(71) Applicant: Molex CVS Dabendorf GmbH, Zossen (DE)

(72) Inventors: Stefan WALLBURG, Berlin (DE); Ulrich MÖHLMANN, Eckental (DE)

(73) Assignees: Molex CVS Dabendorf GmbH, Zossen (DE); Molex CVS Bochum GmbH, Bochum (DE)

(21) Appl. No.: 17/432,505

(22) PCT Filed: Feb. 20, 2020
(86) PCT No.: PCT/EP2020/054470

§ 371 Date: Aug. 20, 2021

(30) Foreign Application Priority Data
Feb. 21, 2019 (DE) 10 2019 202 358.4

(51) Int. Cl. H04W 76/14; H04W 76/15; H04W 84/02; H04W 4/40

(52) U.S. Cl. CPC H04W 76/14; H04W 4/40; H04W 84/02; H04W 76/15

(57) ABSTRACT

The disclosure relates to a method and an apparatus for data transmission, wherein the apparatus has at least one terminal interface for data transmission between the apparatus and a terminal, wherein the apparatus has at least one base station interface for data transmission between the apparatus and the base station, wherein the data transmission between the terminal and the apparatus is effected in a device-to-device communication, characterized in that the apparatus is in the form of a relay apparatus for a data transmission between a terminal and the base station, wherein the same standard is used for the data transmission between the apparatus and the terminal as for the data transmission between the apparatus and the base station, the standard being a mobile radio standard, and to a vehicle.

### TECHNICAL FIELD

The disclosure relates to a method and an apparatus for data transmission and to a vehicle.

### BACKGROUND ART

A so-called terminal-to-terminal communication (device-to-device communication) is known from the prior art, which enables direct data transmission between terminals without the need for data between the terminals via an external network device, e.g. a base station must be transferred. Various mobile radio standards are also known, according to which transmission can take place. In particular, the so-called 5G standard is also known.

Methods are also known in which a terminal serves as a so-called repeater. Such a repeater can, for example, enable a further terminal to transmit data to a more distant hotspot, the hotspot set-up in turn enabling data transmission to an external base station of a mobile radio network.

### SUMMARY

There is a technical problem to create a method and an apparatus for data transmission which improve the availability of a data transmission network for at least one terminal. A further technical problem is to create a vehicle, wherein the availability of a data transmission network is improved at least in the interior of the vehicle. The higher or better the availability, the better the possibility of data transmission from or to the terminal via the data transmission network.

The technical problem is solved by the objects with the features of claims 1, 12 and 13. Further advantageous embodiments of the disclosure result from the subclaims.

Proposed is an apparatus for data transmission, in particular for data transmission from a terminal, for example a mobile or portable terminal such as a mobile radio device or a tablet PC, to a base station of a data transmission network. The base station can designate a stationary transmission device for data. The data transmission can take place via radio signals, in particular via mobile radio signals. Thus, the data transmission network may in particular be a mobile radio network. In other words, the proposed device can be part of a transmission path for data from the terminal to the base station, wherein the data can particularly be mobile radio data.

The apparatus has at least one terminal interface for data transmission between the apparatus and a terminal. The data transmission between the apparatus and the terminal can be carried out according to a predetermined standard or protocol. Preferably, the apparatus has at least one terminal interface for data transmission between the apparatus and a plurality of terminals, or the apparatus has a plurality of terminal interfaces for data transmission between the apparatus and one terminal each. Signals for data transmission can thus be transmitted and/or received by the apparatus via the terminal interface.

The terminal may particularly comprise an input device for user inputs, e.g. a keypad or a so-called touch screen, a microphone, a loudspeaker and/or a display device. The proposed apparatus for data transmission preferably does not form a terminal. Thus, the apparatus may particularly comprise no input device and/or no microphone and/or no loudspeaker and/or no display device.

The apparatus further comprises at least one base station interface for data transmission between the apparatus and a base station. The data transmission between the apparatus and the base station may also be performed according to a predetermined standard or protocol. The standard or protocol for the data transmission between the apparatus and a terminal may be different from the standard or protocol for the data transmission between the apparatus and the base station. However, the same protocols or standards can also be used for said data transmissions. Signals for data transmission can thus be transmitted and/or received by the apparatus via the base station interface.

It is possible that the terminal also has a base station interface for data transmission between the terminal and the base station.

Here, the apparatus can particularly be a stationary device. Particularly, the apparatus is a non-portable apparatus. It can be permanently installed, for example in a vehicle. The apparatus is different from a terminal and a base station.

The data transmission, particularly between the base station and the apparatus, can serve for the transmission of emergency call data, which are necessary in particular for the rapid execution of rescue measures. However, the data transmission can also serve to transmit data that is not or not exclusively such emergency call data.

The data transmission between the apparatus, the base station and the terminal may include a transmission of audio data, video data, data for displaying information and/or data of an input via the terminal. Also, the data transmission may also serve to transmit data for the execution of so-called consumer applications. Consumer applications refer, for example, to applications developed for portable terminals and may also be referred to as so-called apps. Consumer applications can particularly be multimedia applications or enable the use of internet services. Consumer applications can also refer to applications in the infotainment area, e.g. applications in the area of radio, navigation, TV and connectivity.

According to the disclosure, the apparatus is in the form of a relay apparatus for data transmission between a terminal and the base station. The fact that the apparatus is in the form of a relay apparatus for data transmission between the terminal and the base station can mean in particular that the relay apparatus can be used to receive and retransmit signals, in particular radio signals, for the data transmission described. Thus, the data transmission between the terminal and the base station can take place via the apparatus. In other words, the data transmission between the terminal and the base station does not take place directly, but via the proposed apparatus.

Further, the same standard is used for data transmission between the apparatus and the terminal as for data transmission between the apparatus and the base station, the standard being a mobile radio standard.

Furthermore, the data transmission between the terminal and the apparatus takes place in a device-to-device communication (D2D communication, device-to-device communication), namely a D2D communication according to the specifications of a mobile radio standard, e.g. specifications that are defined in the 3 gpp release 15, in particular version 15.2.0. However, it is also possible that the D2D communication takes place according to specifications in further, in particular future, mobile radio standards, e.g. specifications in further, in particular future, versions of the 3 gpp release.

In this context, D2D communication refers to direct communication between the apparatus and a terminal without involving a base station or a core network, which are therefore not part of the transmission path for data of this communication. For the data transmission of a D2D communication, signals can be used whose frequencies lie in a frequency range that is used for signal transmission in a mobile radio network. Alternatively, signals can be used whose frequencies lie outside such a frequency range.

It is possible that signals for data transmission of a D2D communication have frequencies in a frequency range from 400 MHz to 3.5 GHz, preferably in ranges from 3.4 GHz to 3.8 GHz and/or 3.3 GHz to 3.6 GHz and/or 4.4 GHz to 4.5 GHz and/or 4.8 GHz to 4.99 GHz and/or 3.6 GHz to 4.2 GHz and/or 4.4 GHz to 4.9 GHz and/or 3.4 GHz to 3.7 GHz and/or 3.1 GHz to 3.55 GHz and/or 3.7 GHz to 4.2 GHz. Alternatively or cumulatively, these signals may have frequencies greater than or equal to 5 GHz, e.g. equal to 6 GHz. Further alternatively or cumulatively, these signals may have a frequency of 28 GHz or from a frequency range around 28 GHz, such frequency range including the frequency of 28 GHz as a center frequency or off-center frequency and having a width from a range of 0.5 GHz to 6.5 GHz. Further alternatively or cumulatively, said signals may have a frequency of 39 GHz or from a frequency range around 39 GHz, such frequency range including the frequency of 39 GHz as a center frequency or off-center frequency and having a width from a range of 0.5 GHz to 6.5 GHz.

Such frequency ranges may include, for example, a range from 27.5 GHz to 28.35 GHz and/or from 37 GHz to 40 GHz and/or from 26.5 GHz to 29.5 GHz and/or from 27.5 GHz to 28.28 GHz and/or from 24.25 GHz to 27. 5 GHz and/or from 37 GHz to 43. 5 GHz and/or from 26.5 GHz to 27.5 GHz.

Furthermore, frequency ranges in the frequency bands around 600 MHz, 700 MHz, 800 MHz, 900 MHz, 1.5 GHz, 2.1 GHz, 2.3 GHz and/or 2.6 GHz can be used.

It is further possible that the data transmission of the D2D communication takes place in further, in particular in future defined frequency ranges.

In particular, the data transmission of the D2D communication can take place according to a corresponding D2D protocol, especially according to a protocol compatible with the 5G standard. The D2D communication can take place on the so-called PHY layer.

For example, the apparatus may receive a signal transmitted by the terminal via the terminal interface and then transmit it unprocessed, but preferably processed, to the base station via the base station interface. For this purpose, the apparatus may comprise a data processing device.

Alternatively or cumulatively, the apparatus may receive a signal transmitted by the terminal via the terminal interface and transmit it unamplified, but preferably amplified, to the base station. For this purpose, the apparatus may comprise a signal amplification means.

Of course, the apparatus can also receive signals emitted by the base station via the base station interface and transmit them unprocessed or processed and preferably unamplified or attenuated or amplified via the terminal interface to the terminal.

Preferably, the apparatus receives a signal transmitted by the terminal via the terminal interface, amplifies the signal and transmits the amplified signal to the base station, wherein the apparatus receives a signal transmitted by the base station via the base station interface and transmits it unamplified to the terminal. Thus, the apparatus may comprise amplifying equipment for the signal emitted by the terminal but not amplifying equipment for the signal emitted by the base station.

In a D2D communication between the apparatus and the terminal, the apparatus can perform control functions for controlling a data transmission that are performed by the base station in a direct communication between the terminal and the base station, i.e. without involving the apparatus. For example, the apparatus can control the transmission power of the terminal, in particular by transmitting a desired setpoint value of the transmission power to the terminal. Further, the apparatus may synchronize the data transmission with a predetermined clock. Further, the apparatus can sign off a terminal for a data transmission, in particular when no more data transmission has taken place between the apparatus and the terminal for a predetermined period of time.

It is possible that a transmission and/or reception range of the terminal interface of the apparatus is different from a transmission and/or reception range of the base station and that these ranges do not overlap. This advantageously enables data transmission from a terminal located in the transmission and/or reception range of the terminal interface to the base station without the terminal being located in the transmission and/or reception range of the base station, i.e. being in a so-called out-of-coverage state with respect to the base station.

A reception range can designate a spatial area which is assigned to a receiving equipment, wherein a radio signal transmitted by a transmission equipment with a predetermined, e.g. minimum, signal strength can be received by the receiving equipment with a likewise predetermined, e.g. minimum necessary, reception power if the transmission equipment is located in the reception range. If the transmission equipment is outside the reception range, a radio signal transmitted with this predetermined signal strength cannot be received with the predetermined reception power.

A transmission range can designate a spatial area in which a radio signal transmitted by a transmission equipment with a predetermined, e.g. maximum, signal strength can be received by a reception equipment with a likewise predetermined, e.g. minimum necessary, reception power when the reception equipment is located in the transmission range. If the reception equipment is outside the transmission range, a radio signal transmitted with this predetermined signal strength cannot be received with the predetermined reception power.

Alternatively, however, transmission and/or reception areas of the base station and the apparatus, in particular the terminal interface, may at least partially overlap. In this case, however, it may be possible that in overlapping areas a signal transmitted by the base station with a predetermined signal strength is received by a terminal with a lower reception power than a signal transmitted by the apparatus via the terminal interface with the predetermined signal strength and/or a signal transmitted by a terminal with a predetermined signal strength is received by the base station with a lower reception power than by the apparatus via the terminal interface. In this case, too, data transmission via the apparatus can enable better quality data transmission from the terminal to the base station, wherein in particular energy can be saved.

It may be necessary for a terminal to register with the apparatus in a registration process before transmitting data to the base station via the proposed apparatus. If data is no longer to be transmitted to the base station via the apparatus, the terminal can de-register in a de-registration process. Data can be transmitted between the apparatus and the terminal for registration or de-registration. In this case, information about an identifier or an identity of the terminal can be transmitted to the apparatus. Alternatively, a terminal can also be de-registered by the apparatus, in particular if no signal is received from and/or transmitted to the terminal for a predetermined period of time.

Further, the relay functionality of the apparatus may be activatable and deactivatable, for example by sending an activation signal or a deactivation signal from the terminal or the base station. An activation signal may in particular encode an activation command.

Overall, this advantageously results in better availability of a data transmission network provided by a base station for a mobile terminal in particular.

In a further embodiment, the data transmission between the terminal and the base station is a data transmission in accordance with the 5G standard. Thus, the data transmission between the terminal and the apparatus and between the apparatus and the base station can also be in accordance with the 5G standard. In this case, the apparatus can be in the form of a so-called 5G-relay apparatus. This advantageously enables data transmission with a high bandwidth in accordance with the 5G standard in areas where the transmission power and/or reception sensitivity of a base station is low or non-existent.

In another embodiment, the apparatus is a network access device. A network access device may also be referred to as a network access device. Here, the network access device can provide access to an external network, for example a data transmission network, for devices that are different from the terminals. In particular, the network access device can also enable the outlined access for devices that are fixed in place, for example devices that are fixed in place in a vehicle, for example devices that are fixed to the vehicle, such as control devices. The network access device can thus also be a stationarily installed device.

A network access device can also be referred to as a so-called modem and can perform modem-specific functions, i.e. functions that are required to perform functions of a modem. This can comprise one or more computing device(s), e.g. computing device(s) in the form of a microcontroller or integrated circuits.

This advantageously results in the already existing functionality of a network access device, namely enabling data transmission to and from a network device, for example a base station, being used to also enable data transmission to and from a terminal. This makes it possible to reduce manufacturing costs and space requirements for the device, in particular if an existing network access device is used as the proposed device for data transmission.

In a further embodiment, the device is a telematics control unit or part of a telematics control unit. A telematics control unit can be used to carry out telematic services, in particular in a vehicle. The telematics control unit can include a GNSS device. Furthermore, the telematics control unit can comprise a computing device, for example a computing device in the form of a microcontroller or an integrated circuit. The telematics control unit can furthermore comprise a storage device for data.

The telematics control unit can furthermore comprise a bus interface, via which the telematics control unit can be connected to a bus system for data transmission, for example a vehicle bus system.

This also results in an advantageous integration of the apparatus in already existing apparatuses, wherein costs and installation space can be saved.

In a further embodiment, the network access device forms the network access device of a telematics control unit. This also results in the outlined advantageous integration.

In a further embodiment, functions of the telematics control unit can be executed with a computing device of the network access device. In other words, the computing devices of the network access devices can be used to carry out operations that are necessary when operating the telematics control unit to carry out functions that are provided by the telematics control unit. For example, the telematics control unit can execute so-called eCall functions. The telematics control unit can also carry out V2x communication functions.

Furthermore, for example, a computing device of the network access device can be used for bus control of the telematics control unit, wherein the telematics control unit is connected to the explained bus system. This can mean that the computing device of the network access device controls the data transmission of the telematics control unit via the bus system, in particular according to one or more predetermined protocol(s).

This advantageously results in the high-performance computing device of the network access device, which is usually designed to provide the previously explained modem and relay functionality, also executes functions of the telematics control unit, wherein space and costs can be saved through these synergy effects.

It is also conceivable that the network access device uses a memory device of the telematics control unit to store and retrieve data that are required, for example, for the execution of modem-specific functions and/or relay-specific functions by the network access device. Relay-specific functions can designate functions that are required to carry out functions of a relay. These functions can in particular include data processing, which is explained in more detail below. Alternatively or cumulatively, the telematics control unit can also use a memory device of the network access device for storing and retrieving data that are required, for example, to carry out functions of the telematics control unit.

The telematics control unit and the network access device can be in the form of separate devices, in particular as structurally separate devices. In this case, these devices can be arranged at different points in the vehicle, although the devices can be connected in terms of signaling and/or data technology. However, it is also conceivable to design both as a structural unit, in particular devices arranged in a housing.

In a further embodiment, the apparatus is arranged in a vehicle. The vehicle can in particular be a motor vehicle, further in particular a passenger car. In this case, the apparatus can also be referred to as a vehicle-fixed apparatus. In particular, the apparatus can be arranged in a stationary manner relative to the vehicle in the latter. It is possible here for a transmission and/or reception range of the terminal interface to encompass the entire vehicle interior or a predetermined sub-area of the vehicle interior. This results in an advantageous manner that terminals in the vehicle interior, in particular mobile radio devices, can establish a good data connection to a base station external to the vehicle, namely via the proposed apparatus, despite the electromagnetic shielding by the vehicle body.

A use of an apparatus according to one of the embodiments disclosed in this disclosure in the vehicle, in particular for data transmission between a terminal, which can be arranged in the vehicle, and a base station, which can be arranged outside the vehicle, is further described.

In a further embodiment, the apparatus can process the data during the data transmission between the terminal and the base station. Data processing can in particular be data processing that is necessary for frequency conversion of a signal used for data transmission. Here, a signal from one frequency range can be converted into another frequency range. This means that a converted signal has different frequencies after the conversion than before the conversion. For example, a frequency conversion can take place between a signal which is used for data transmission between the base station and the apparatus and a signal which is used for data transmission between the apparatus and the terminal.

Alternatively or cumulatively, the data processing can be data processing that is necessary to convert a signal transmitted using a TDD (Time Division Duplex) method into a signal transmitted using an FDD (Frequency Division Duplex) method or vice versa.

Furthermore, alternatively or cumulatively, the data processing can be data processing that is necessary for converting a data transmission according to a specific protocol into another protocol. Here, for example, a signal transmitted according to a first protocol can be converted into a signal transmitted according to a further protocol that is different from the first protocol. For example, the signal transmission between the apparatus and the base station can take place in accordance with a protocol which is different from the protocol of the data transmission between the apparatus and the terminal.

Furthermore, alternatively or cumulatively, the data processing can result in data processing that is necessary for what is known as tunneling. Tunneling can denote a conversion and transmission according to a communication protocol which is embedded in another communication protocol for data transmission. In other words, during tunneling, an existing communication network can be used as a transport medium for a self-contained further communication network, which in particular can be a VPN (virtual private network). This advantageously results in a secure connection between the terminal and the base station.

Overall, the data processing advantageously results in a wide range of applications for the proposed relay apparatus, in particular as it is suitable for data transmission between a plurality of base stations and a plurality of different terminals due to the explained data processing functionality.

In a further embodiment, the apparatus has multiple terminal interfaces for data transmission between the apparatus and at least one, preferably exactly one, terminal, wherein the apparatus is in the form of a relay apparatus for data transmission between the multiple terminals and the base station. Data can be transmitted via the various terminal interfaces, for example, according to different protocols and/or according to different standards. This advantageously enables data transmission between the respective terminal and the base station to be made possible or improved for several terminals at the same time.

In a further embodiment, the apparatus can be used to detect a number of terminals in a reception range of the apparatus, in particular in a reception range of the terminal interface. In particular, a number of terminals registered for data transmission to the base station via the apparatus can be detected.

Thus, it can be detectable, for example, how many terminals are located in a vehicle interior of a vehicle. This information can be used, for example, in an eCall scenario; in particular, information about the number detected in this way can also be transmitted when a so-called eCall is emitted. In this way, it can be achieved in an advantageous manner that emergency services can be informed precisely or at least approximately about the number of people in the vehicle, wherein it can be possible to assume that there is one person per terminal in the vehicle interior. This can be important, for example, to determine the number of ambulances that will be sent to an accident site.

It may further be possible that an identifier or identity of a terminal in the reception range of the apparatus can also be detected by means of the apparatus. For example, the apparatus can detect which terminals are located in the reception range, in particular which terminals are registered with the apparatus for data transmission via the apparatus to the base station.

This results advantageously that the availability of a desired terminal can be checked in a targeted manner or that a targeted data transmission to a desired terminal can take place. For example, after an accident, it can be specifically checked whether a certain terminal can be reached for a data transmission. This can be used in particular to check whether a specific vehicle occupant has left the accident site after an accident.

In a further embodiment, the apparatus can be used to detect a distance between a terminal in the reception range, in particular a registered terminal, as explained earlier, and the apparatus. The distance can be detected by means of level evaluation or time-of-flight. Thus, the apparatus can comprise an apparatus for level detection and/or for detecting a signal propagation time between the apparatus, in particular the terminal interface, and the terminal.

If several terminals can be detected in the reception range by means of the apparatus, a level and/or a run time and thus also a distance can be assigned to one of these several terminals. If an identity/identifier of the terminal can be determined, the level and/or the run time and thus also the distance can be assigned to this identifier.

Information about a distance or the distance assigned to a specific terminal can also be used advantageously in an eCall scenario. For example, such information can be transmitted when the eCall is emitted. In this way, rescue workers can advantageously obtain an estimate of the range around the apparatus in which people are located, in particular if it is assumed that a terminal is assigned to a person. This can be important, for example, if a confused vehicle occupant leaves the vehicle after an accident.

A vehicle with an apparatus according to an embodiment described in this disclosure is also proposed. Here, the apparatus can be arranged in the vehicle as outlined above. The apparatus, in particular the base station interface, can be connected to a vehicle antenna in terms of signaling. This advantageously results in a vehicle which improves data transmission between terminals located in the vehicle and a base station.

Further proposed is a method for data transmission between at least one terminal and a base station, wherein the apparatus according to one of the embodiments described in the present disclosure serves as a relay apparatus for data transmission between the terminal and the base station, and the data transmission between the terminal and the apparatus is a D2D communication or is carried out as a D2D communication. This means that data are transmitted from the terminal to the apparatus in a D2D communication and from there to the base station. Conversely, data can be transmitted from the base station to the apparatus and from there to the terminal in a D2D communication. Furthermore, the same standard is used for the data transmission between the device and the terminal as for the data transmission between the apparatus and the base station, wherein the standard is a mobile radio standard.

Signal processing, which was outlined above, can take place here. This advantageously results in improved data transmission between the terminal and the base station. The method can be carried out with an apparatus according to one of the embodiments described in this disclosure. Thus, the apparatus is configured in particular in such a way that such a method can be carried out with the apparatus.

When operating the apparatus, in particular when operating as a relay, it is also possible—as outlined above as well—to detect a number of terminals in the reception range of the apparatus. Alternatively or cumulatively, a distance between a terminal and the apparatus can also be detected.

### BRIEF DESCRIPTION OF THE DRAWINGS

The disclosure is explained in more detail using exemplary embodiments. The figures show:

FIG. 1 shows a schematic view of a vehicle with an apparatus according to the disclosure and a base station,

FIG. 2 shows a schematic block diagram of an apparatus according to the disclosure as well as a base station and a terminal,

FIG. 3 shows a schematic block diagram of an apparatus according to the disclosure in accordance with a further embodiment with base station and terminal,

FIG. 4 shows a schematic block diagram of an apparatus according to the disclosure in accordance with a further embodiment with a plurality of terminals and a base station and

FIG. 5 shows a schematic flow diagram of a method according to the disclosure.

### DETAILED DESCRIPTION OF THE PREFERRED EMBODIMENTS

In the following, the same reference symbols designate elements with the same or similar technical features.

FIG. 1 shows a schematic block diagram of an apparatus 1 according to the disclosure for data transmission between a terminal 2a, 2b and a base station 3. The data transmission can be wireless data transmission, in particular by means of radio signals. The apparatus 1 is arranged in a vehicle 4, in particular stationary relative to a vehicle-specific coordinate system.

The apparatus 1 comprises at least one terminal interface 5 for data transmission between the apparatus 1 and the terminals 2a, 2b.

The terminals 2a, 2b can be, for example, portable terminals such as cell phones, portable PCs such as tablets or other terminals that have an interface for data transmission between the terminal 2a, 2b and other devices, in particular via a data transmission network such as the Internet. The other devices can be, for example, server devices of the data transmission network.

Usually, a data transmission to such server devices is carried out by directly transmitting data between a terminal 2a, 2b and a base station 3, whereby a data transmission, in particular a wired data transmission, is then carried out between the base station 3 and the server device.

In the case of direct data transmission between terminal 2a, 2b and base station 3, signals for data transmission can be transmitted by terminal 2a, 2b and received by base station 3 or signals can be transmitted by base station 3 and received by terminal 2a, 2b. The data transmission between a terminal 2a, 2b and a further device, e.g. the server device of the previously explained data transmission network, can thus be carried out via the base station 3. In other words, the base station 3 forms part of the data transmission link. In this context, a base station 3 refers to a preferably stationary transmission device for signals, in particular radio signals, e.g. from mobile radio networks.

The apparatus 1 also has at least one base station interface 6. This is used for data transmission, in particular wireless data transmission, e.g. via radio signals, between the apparatus 1 and the base station 3.

According to the disclosure, the apparatus is in the form of a relay apparatus for data transmission between a terminal 2 a, 2 b and the base station 3. Thus, the data transmission between a terminal 2a, 2b and the base station 3 does not usually take place directly, as outlined above, but rather by transmitting signals for data transmission from the terminal 2a via the terminal interface 5 to the apparatus 1. These are then received by the apparatus 1. Furthermore, these signals can be transmitted unprocessed or processed via the base station interface 6 to the base station 3. A data transmission from the base station 3 to a terminal 2a, 2b can take place in that signals are transmitted from the base station 3 and received by the apparatus 1 via the base station interface 6. These signals can then be transmitted unprocessed or processed via the terminal interface 5 to a terminal 2a, 2b and transmitted.

Thus, a device-to-device transmission (device-to-device communication) can take place between a terminal 2a, 2b and the apparatus 1.

In this case, the apparatus 1 can amplify the signals used for data transmission, in particular the radio signals. This involves preferably signal amplification of signals received from the terminal 2a, 2b, the amplified signals then being transmitted to the base station 3, but preferably no signal amplification of signals received from the base station 3 and transmitted to a terminal 2a, 2b.

For this purpose, the apparatus 1 may comprise a corresponding amplifier device (not shown). The amplifier device can be electrically connected to an energy supply device arranged in the vehicle, for example via an on-board network.

As already outlined, data processing can also be carried out by the apparatus 1.

The data transmission between the apparatus 1 and the base station 3 can be a data transmission according to a mobile radio standard. Furthermore, the same standard can be used for data transmission between the apparatus 1 and the terminal 2a, 2b.

The data transmission between the terminal 2a, 2b and the base station 3 via the apparatus 1 is preferably a data transmission in accordance with the 5G standard. In this case, the data transmission between the terminal 2a, 2b and the apparatus 1 as well as the data transmission between the apparatus 1 and the base station 3 can each be a data transmission in accordance with the 5G standard. However, a direct data transmission between the terminal 2a, 2b and the base station, i.e. without integration of the apparatus 1, can also be carried out according to a standard different from the 5G standard.

The data transmission can take place in particular when emitting an eCall. The data transmission can also serve V2X communication. In addition, however, the data transmission can be used to carry out or execute consumer applications.

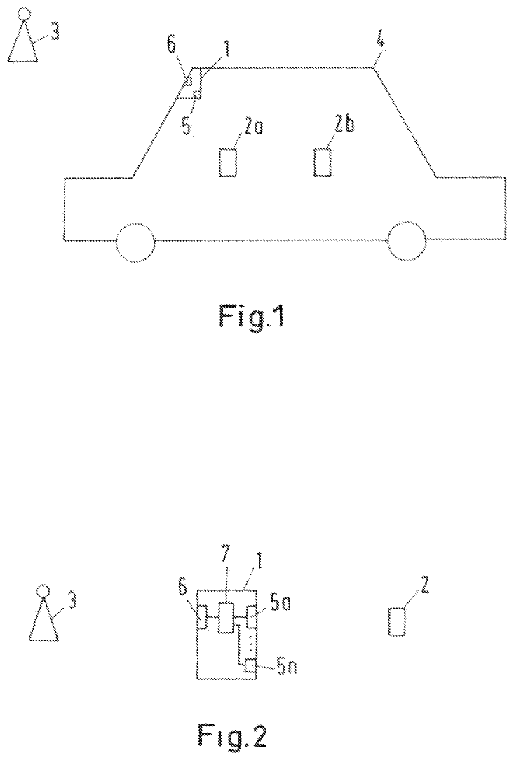

FIG. 2 shows a schematic block diagram of an apparatus 1 according to the disclosure in a further embodiment as well as a base station 3 and a terminal 2. In contrast to the embodiment of the apparatus 1 shown in FIG. 1, the apparatus 1 is shown as comprising several terminal interfaces 5a, . . . , 5n. A computing device 7 of the apparatus 1 is also shown, whereby this is connected in terms of data and/or signals to the terminal interfaces 5a, . . . , 5n and to a base station interface 6. The several terminal interfaces 5a, . . . , 5n can each be used for data transmission between the apparatus 1 and a terminal 2 of a set of several terminals 2. The data transmission between the apparatus 1 and these terminals 2 via the corresponding terminal interfaces 5a, . . . , 5n can be carried out according to the same or different standards or with the same or different protocols.

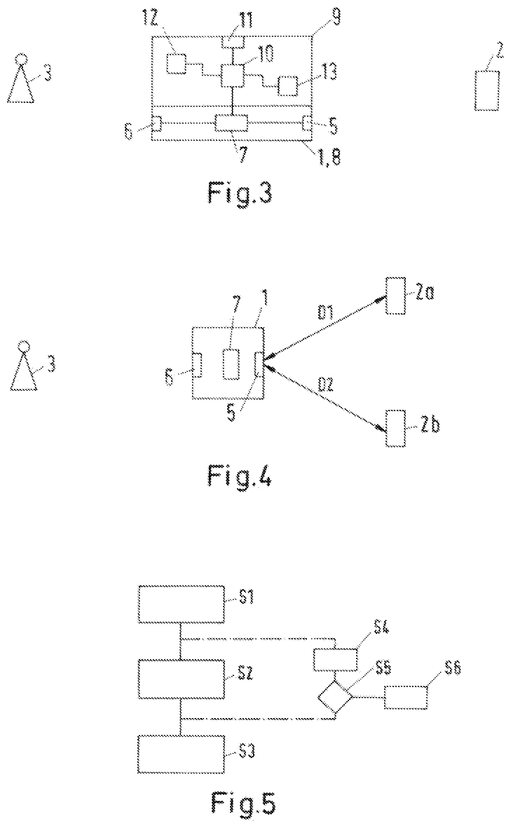

FIG. 3 shows a schematic block diagram of an apparatus 1 according to a further embodiment as well as a terminal 2 and a base station 3. The apparatus 1 is a network access device 8 or forms such a network access device 8. A network access device 8 can in particular be in the form of a modem. The network access device 8 comprises a computing device 7 and a base station interface 6, via which data can be transmitted between the previously outlined data transmission network and the network access device 8 via the base station 3. The network access device 8 further comprises one or more terminal interfaces 5.

FIG. 3 shows that the network access device 8 is part of a telematics control unit 9. The telematics control unit 9 can in particular be the telematics control unit 9 of a vehicle 4 (see FIG. 1). The telematics control unit 9 comprises a computing device 10 and a bus interface 11, via which data can be transmitted between the telematics control unit 9 and other vehicle devices, for example control devices, the data being transmitted in particular via a bus system such as a CAN bus.

Also, it is shown that the telematics control unit 9 comprises a GNSS device 12. The telematics control unit 9 can furthermore comprise a storage device 13.

The computing device 10 of the telematics control unit 9 is connected in terms of signals and/or data to the GNSS device 12, the storage device 13, the interface 11 and the computing device 7 of the network access device 8. It is possible here for the computing device 7 of the network access device 8 to carry out functions of the telematics control unit, for example the control of the interface 11 for data transmission.

Computing devices 7, 10 can be implemented as microcontrollers or integrated circuits, for example.

FIG. 4 shows a schematic block diagram of an apparatus 1 in a further embodiment as well as terminals 2a, 2b and a base station 3.

Here, the apparatus 1, which, as outlined above, comprises a terminal interface 5, a base station interface 6 and a computing device 7, can determine a distance D1 to a first terminal 2a and a distance D2 to a second terminal 2b, is shown. The determination can take place here by means of the computing device 7. The distance can be determined by means of level evaluation or time-of-flight. For this purpose, the apparatus 1 can include appropriate devices for detecting a level of a signal for data transmission between the apparatus 1 and the respective terminals 2a, 2b or a run time of a signal for data transmission between the apparatus 1 and the respective terminals 2a, 2b.

The apparatus 1 can also be used to determine the number of terminals 2a, 2b which are arranged in a reception range of the apparatus 1, in particular the terminal interface 5. A number of terminals 2a, 2b can also be detected which are in a signaling connection with the apparatus 1 via the terminal interface 5 for data transmission or which are registered with the apparatus 1 for data transmission via the apparatus 1. For example, it may be necessary for a terminal device 2a, 2b to register with the apparatus 1 before carrying out a data transmission, in particular via a corresponding registration process. In this case, the apparatus can determine or detect the number of registered terminals 2a, 2b. It is also possible for the apparatus to also determine an identifier or identity of the terminal devices 2a, 2b arranged in the reception range or of the terminal devices 2a, 2b registered with the apparatus for data transmission. Furthermore, as outlined above, the corresponding distance D1, D2 to these terminals can be determined.

FIG. 5 shows a schematic flow diagram of a method according to the disclosure for data transmission between at least one terminal 2 and a base station 3 (see, e.g. FIG. 3). In a first step S1, data is transmitted from the terminal 2 via a terminal interface 5 to the apparatus 1, for example by means of suitable signals. In a second step S2, these data or signals are processed, with exemplary processing operations having been explained above. In a third step S3, the data are transmitted from the apparatus 1 to the base station 3 via the base station interface 6.

Alternatively, in the first step S1, data can be transmitted from the base station 3 to the apparatus 1 via the base station interface 6, these being processed in the second step S2. In a third step S3, the data are transmitted from the apparatus 1 to the terminal 2 via the terminal interface 5.

Here, the same standard can be used for the data transmission between the apparatus 1 and the terminal 2 as for the data transmission between the apparatus 1 and the base station 3, the standard being a mobile radio standard. Furthermore, the data transmission between the terminal 2 and the apparatus 1 can take place according to a D2D communication.

It should be noted here that the second step S2 is an optional step, since the signal or data processing is not absolutely necessary. Alternatively or cumulatively, the signal used for data transmission can also be amplified in a second step. This amplification can in particular only take place when a signal has been received by the terminal 2 and is transmitted to the base station 3. No amplification can take place if a signal is received by the base station 3 and transmitted to a terminal 2.

The semicolon lines in FIG. 5 show that when the apparatus 1 is operated as a relay, i.e. in particular in parallel with the data transmission between the apparatus 1 and the terminal 2 or the apparatus 1 and the base station 3, a number of terminals 2 can be determined in a fourth step S4 which are located in the reception range of the apparatus 1 or which are registered with the apparatus 1 for data transmission. In a fifth step S5, it can be evaluated whether conditions for an automatic emergency call (eCall) are fulfilled. If this is the case, in a sixth step S6 an automatic emergency call can be emitted by the apparatus 1, for example via the base station interface 6, the information transmitted with this emergency call comprising information about the number of terminals 2 determined in the fourth step S4. Furthermore, the information transmitted in the emergency call can also comprise information about distances D1, D2 (see FIG. 4) between the terminals 2 in the reception area of the apparatus 1 determined in the fourth step S4, wherein these distances D1, D2 can also be determined in the fourth step S4. In this way, rescue workers can advantageously be informed of important information for carrying out effective rescue operations.

1. A system for data transmission,
an apparatus that includes a terminal interface for data transmission between the apparatus and a terminal and a base station interface for data transmission between the apparatus and a base station, the data transmission between the terminal and the apparatus takes place in a device-to-device communication, wherein the apparatus is configured to act as a relay apparatus for data transmission between the terminal and the base station, wherein the data transmission between the apparatus and the terminal uses the same standard as is used for data transmission between the apparatus and the base station, wherein the standard is a mobile radio standard.

2. The system of claim 1, wherein that the data transmission between the terminal and the base station is data transmission in accordance with the 5G standard.

3. The system of claim 2, wherein the apparatus is a network access device.

4. The system of claim 2, wherein that the apparatus is at least part of a telematics control unit.

5. The system of claim 4, wherein the apparatus is a network access device of the telematics control unit.

6. The system of claim 5, wherein a computing device of the network access device is configured to provide functions of the telematics control unit.

7. The system of claim 1, wherein the apparatus is arranged in a vehicle.

8. The system of claim 1, wherein the apparatus is configured to process data being transferred during data transmission between the terminal and the base station.

9. The system of claim 1, wherein the apparatus includes a plurality of terminal interfaces, each of the terminal interfaces configured to provide data transmission between the apparatus and the respective terminal, wherein the apparatus is in the form of a relay apparatus configured for data transmission between a plurality of terminals and the base station.

10. The system of claim 1, wherein the apparatus is configured to detect a plurality of terminals that are positioned in a reception range of the apparatus.

11. The system of claim 10, wherein the apparatus is configured to detect a distance between the apparatus and the terminals positioned within the reception range.

12. The system of claim 11, wherein the apparatus is positioned in a vehicle.

13. A method for data transmission between a terminal and a base station, comprising:
providing a relay apparatus for data transmission between the terminal and the base station with an apparatus according to claim 1, wherein the data transmission between the terminal and the apparatus takes place in a device-to-device communication manner, wherein the apparatus uses a standard for the data transmission between the apparatus and the terminal and the apparatus uses the standard for data transmission between the apparatus and the base station, wherein the standard is a mobile radio standard.
